(19) United States
(12) Patent Application Publication
(10) Pub. No.: US 2007/0056911 A1
(43) Pub. Date: Mar. 15, 2007

(54) Selective removal of toxic compounds like arsenic from drinking water using a polymeric ligand exchanger

(76) Inventors: Dongye Zhao, Auburn, AL (US); Byungryul An, Auburn, AL (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/445,757

(22) Filed: Jun. 2, 2006

Related U.S. Application Data
(60) Provisional application No. 60/687,611, filed on Jun. 3, 2005.

(51) Int. Cl. C02F 1/28

(52) U.S. Cl. 210/670; 210/683; 210/684

(57) ABSTRACT

A method of removing toxic compounds from water comprises the steps of providing a polymeric ligand exchanger having a chelating resin containing nitrogen electron donor atoms and a transition metal ion bonded with the nitrogen donor atoms on the surface of the chelating resin, and contacting water containing a toxic compound with the polymeric ligand exchanger to remove the toxic compound from the water. The preferred metal ion is a cupric ion, and the preferred toxic compound to be removed from water is arsenic. The method further includes the step of regenerating the polymeric ligand exchanger with brine and the step of treating the brine used to regenerate the polymeric ligand exchanger with iron chloride to remove arsenate therefrom so that the brine may be re-used in the system to reduce the overall volume of waste material.

### CROSS REFERENCE TO RELATED APPLICATION

This application claims priority to and the benefit from U.S. Provisional Application No. 60/687,611 filed on Jun. 3, 2005.

### RESEARCH OR DEVELOPMENT

This research was funded in part by the U.S. Environmental Protection Agency through Grant RD-83143101-0 and the American Water Works Association Research Foundation through Project-3076. The United States government may have certain rights to this invention.

### BACKGROUND OF THE INVENTION

The presence of arsenic (As) in the U.S. waters is widespread. It is estimated that about 16.4% of groundwater sources exceeded 5 μg/L in various regions of the country. The U.S. EPA estimates that approximately 2% of the U.S. population receives drinking water containing greater than 10 μg/L As, and the Natural Resources Defense Council estimates that about 56 million people in the U.S.are drinking water with As at unsafe levels.

Arsenic has been associated with various cancerous and non-cancerous health effects. According to a recent report by the National Academy of Science (NAS) and National Research Council (NRC), even at 3 μg/L of As, the risk of bladder and lung cancer is between 4 and 7 deaths per 10,000 people. At 10 μg/L, the risk increases to between 12 and 23 deaths per 10,000 people. In addition, As can cause high blood pressure and diabetes.

Triggered by the risk concern, the U.S. EPA announced its ruling in October 2001 to lower the maximum contaminant level (MCL) from the current 50 μg/L (established in 1942) to 10 μg/L with a compliance date of Jan. 22, 2006. This ruling poses tremendous impacts on water utilities. Approximately 4,100 water utilities serving about 13 million people are affected by the law. The compliance cost has been estimated to be about $600 million per year using current treatment technologies. For instance, almost half of the wells in Albuquerque, N.Mex., will require additional treatment to meet the new standard. In the State of Maine, 12% of community water systems will need additional treatment.

In general, three types of treatment technologies are commonly cited for As removal, including modified conventional treatment (MCT) (Chwirka et al., 2004; Ghurye et al., 2004; Fan et al., 2003; Brandhuber and Amy, 1998; McNeill and Edwards, 1997; Herring and Elimelech, 1996; Scott et al., 1995), sorption using activated alumina (AA) (Wang et al., 2002), standard ion exchange resins (IX) (Clifford, 1999) or iron-coated sand (Benjamin et al., 1996), and reverse osmosis (RO) (EPA, 2002). The treatment cost increases in the order of: MCT <<AA or IX <RO. MCT employs various coagulants to enhance As removal in a conventional water treatment process. However, it is extremely difficult to meet the new MCL using MCT alone. Therefore, additional treatment such as microfiltration is often required. Other processes such as IX using strong base anion (SBA) resins or AA adsorption or RO are less cost-competitive due to lack of selectivity for As, frequent regeneration requirements and production of large volumes of As-laden process residuals. To meet the urgent technology needs, a number of other technologies are also being explored, including electro-coagulation (Kumar et al., 2004), polymer inclusion membrane process (Ballinas et al.,2004), mesoporous alumina sorption (Kim et at., 2004), activated mud(Genc et al., 2004) and ferrihydrite crystallization process (Richmond et al., 2004). However, these new techniques are in the developmental stage. Consequently, innovative cost-effective treatment processes are urgently needed.

IX is currently an EPA-identified best available technology (BAT) for removal of As. However, current commercial strong base anion (SBA) resins suffer from poor selectivity for arsenic. Due to the strong competition from some ubiquitous anions such as sulfate, the arsenic capacity of SBA resins is prohibitively retarded. For example, the binary arsenate/sulfate separation factor for a typical SBA resin is 0.1 to about 0.5 (a separation factor of less than 1 indicates the resin's preference toward the competing ions). As a result, the As breakthrough occurs before sulfate, and chromatographic peaking of As, i.e. effluent concentration exceeds influent concentration, is often observed.

Due to the lack of As-selectivity, current IX processes require frequent regeneration. As a result, large amounts of regenerant brine are needed, which in turn results in large volumes of As-laden process residuals. The spent regenerant brine and the associated waste residuals contain high levels of As, and often fall into the category of hazardous waste that is subject to stringent disposal and management requirements under the Clean Water Act (CWA) and the Resource Conservation Recovery Act (RCRA).

The concept of ligand-exchange-based separation was first introduced by Helfferich (1962). Generally, a PLE is composed of: a) a cross-linked hosting resin that can firmly bind with a transition metal such as copper and iron, and b) metal ions that are immobilized to the functional groups of the hosting resin. While sharing many common features with standard ion exchangers, a ligand exchanger employs transition metal ions as its terminal functional groups. As a result, ligand exchange involves concurrent Lewis acid-base (LAB) interactions (metal-ligand complexation) and electrostatic interactions between the fixed metal ions, and target anionic ligands. While conventional anion exchangers' selectivity for various anions is governed by electrostatic interactions, the affinity of a PLE is predominated by both the ligand strength and ionic charge of the ligands.

In his pioneer work, Helfferich (1962) prepared some of the very first PLEs by loading a transition metal (Ni or Cu) onto commercial cation exchange resins. Because the charges of the loaded metal ions are neutralized by the negative charges of the resins' functional groups, the PLEs could only sorb some neutral ligands such as ammonia and diamine. Later, Chanda et al. (1988) prepared a new PLE for selective removal of arsenic by loading ferric ions onto a weak base chelating resin (known as DOW 3N and available from Dow Chemical Company) with di(2 picolyl)amine groups. They observed that this PLE was able to remove about 140 bed volumes (BVs) of arsenate-laden water and the saturated PLE can be regenerated using I M of NaOH. However, because of the weak Lewis acid characteristics of ferric ions, the amount of Fe³⁺ loaded was low. As a result, the PLE's capacity for arsenate was very limited. Moreover, the loaded iron was nearly completely stripped off the hosting resins during regeneration and reloading of Fe³⁺ was necessary after each cycle of operation. Realizing the critical drawbacks of Fe³⁺ ions, Ramana and SenGupta (1992) prepared a PLE by loading Cu²⁺ onto a weak base chelating resin (known as DOW 2N and available from Dow Chemical Company) with 2-picolylamine groups. Since Cu²⁺ is a much stronger Lewis acid than Fe³⁺, which is in accord with the Irving and Williams order, a much greater metal-loading capacity was observed. The copper loaded DOW 2N showed orders of magnitude greater selectivity for arsenate and selenate in the presence of competing sulfate ions than commercial SBA resins.

To achieve selective removal of phosphate, Zhao and SenGupta (1997) developed and characterized a model PLE, referred to as DOW 3N—Cu, by loading Cu²⁺ ions onto the chelating resin DOW 3N resin. Compared to DOW 2N, DOW 3N contains one more (2picolyl)amine group per functional group. As a result, the copper capacity for DOW 3N nearly doubles that for DOW 2N. DOW 3N—Cu showed unusually high selectivity for phosphate in the presence of high concentrations of sulfate, chloride, nitrate and bicarbonate (Zhao and SenCmpta, 1998). FIG. 1 depicts the functional group of such a PLE, where a chelating resin containing nitrogen as electron donor atoms is employed as the metal hosting polymer. Metal ions (Cu²⁺) are firmly immobilized on the polymer surface by covalently bonding with the N donor atoms. Since the nitrogen atoms are predominately in their free base form at pH>3, the positive charges of loaded Cu²⁺ ions remain available to interact with anions in the aqueous phase. Moreover, since only a fraction of the copper's 6 coordination bonding sites are consumed for binding copper onto the polymer surface, the immobilized Cu²⁺ ions remain capable of complexing with target ligands from the aqueous phase. Consequently, the Cu²⁺-loaded PLE can interact with strong anionic ligands such as arsenate in water through concurrent Lewis acid-base interaction and electrostatic interactions, leading to enhanced selectivity for stronger ligands such as arsenate.

Building upon prior work on selective phosphate removal and considering the analogous ionic and ligand characteristics between arsenate and phosphate, this present study aims to examine the effectiveness of using DOW 3N loaded with various transition metal ions, and preferably DOW 3N—Cu for selective removal of arsenate and other toxic contaminants/compounds from drinking water. The specific objectives of this study are to 1) probe the equilibrium sorption capacity of DOW 3N—Cu for arsenate in the presence of high concentrations of competing sulfate; 2) test arsenate breakthrough behaviors in a multi-component system; 3) determine the effect of pH; 4) test the regenerability of the arsenate saturated PLE; and 5) examine the treatability and reusability of spent regenerant brine.

### SUMMARY OF THE INVENTION

A method of removing toxic compounds from water, comprises the steps of providing a polymeric liquid exchanger having a chelating resin containing nitrogen electron donor atoms and a transition metal ion bonded with the nitrogen donor atoms on the surface of the chelating resin, and contacting water containing a toxic compound with the polymeric liquid exchanger to remove the toxic compound from the water.

The metal ion is selected from the group consisting of a cupric ion (Cu²⁺), a cuprous ion (Cu¹⁺), a ferric ion (Fe³⁺), a ferrous ion (Fe²⁺), a nickel ion (Ni²⁺), a zinc ion (Zn²⁺), a ziroconium ion (Zr⁴⁺), a cobalt ion (Co²⁺), a chromium ion (Cr³⁺), and mixture thereof. The preferred metal ion is a cupric ion.

The toxic compound is selected from the group consisting of arsenic, selenium, cyanide, perchloride, and mixture thereof. The preferred toxic compound to be removed is arsenic.

The method further includes the step of regenerating the polymetric ligand exchanger with brine, preferably brine containing sodium chloride, and the step of treating the brine used to regenerate the polymeric ligand exchanger with an iron chloride such as ferric chloride (FeCl₃) or ferrous chloride (FeCl₂.4H₂O) to remove the toxic contaminant/compound, e.g. arsenate, therefrom so that the brine many be re-used in the system to reduce the overall volume of waste material.

A preferred polymeric ligand exchanger (PLE) is prepared by loading Cu²⁺ to a commercially available chelating ion exchange resin which contains a functional group having the formula: 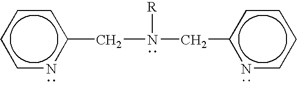
when R is the repeating monomer. Results from batch and column experiments indicate the PLE's unusually high selectivity for arsenate, selenate, cyanate, and perchlorate over other ubiquitous anions such as sulfate, bicarbonate and chloride. For example, the average binary arsenate/sulfate separation factor for the PLE was determined to be 12, which is over two orders of magnitude greater than that (0.1 to about 0.2) for commercial strong-base anion (SBA) exchangers. Because of the enhanced arsenate selectivity, the PLE is able to treat about 10 times more bed volumes of water than commonly used SBA resins. The PLE can operate optimally in the neutral pH range (6.0 to about 8.0).

The exhausted PLE can be regenerated highly efficiently. More than 95% arsenate capacity can be recovered using about 30 BVs of 4% (w/w) NaCl at pH 9.1, and the regenerated PLE can be reused without any capacity drop. Upon treatment using FeCl₃, the spent brine may be recovered and reused for regeneration, which greatly cuts down the regenerant need and reduces the volume of process waste residuals. In summary, this PLE can be used as a highly selective and reusable sorbent for removal of arsenate and other toxic contaminants from drinking water.

### BRIEF DESCRIPTION OF THE DRAWINGS

FIG. 1 is a schematic illustration of the functional group of a polymeric ligand exchanger showing a chelating resin containing nitrogen as electron donor atoms employed as a polymer hosting metal ions, preferably cupric ions (Cu²⁺), which are immobilized on the polymer surface by covalently bonding with the nitrogen donor atoms;

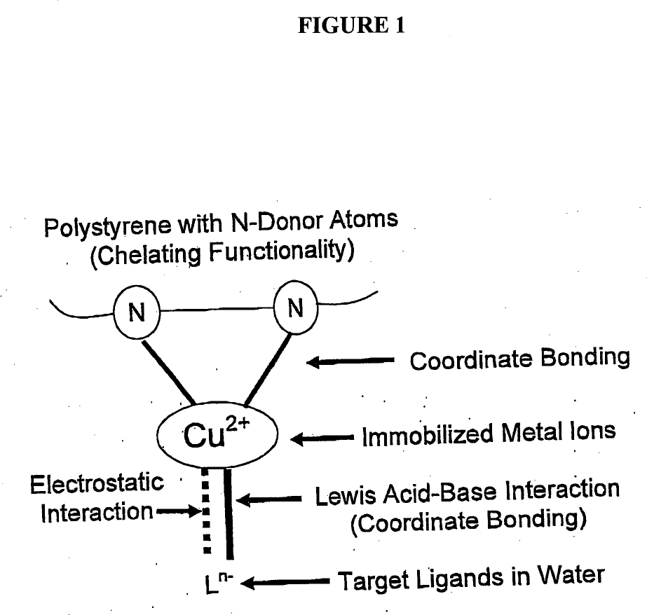

FIG. 2 is a graph illustrating arsenate sorption isotherms for three different chelating resins in the presence of competing sulfate ions;

FIG. 3 is a graph illustrating the breakthrough histories of arsenate and competing chloride and sulfate anions in a fixed bed column exchanger using a standard commercially available strong-base anion (SBA) resin, IRA 900;

FIG. 4 is a graph similar to FIG. 3 except illustrating the breakthrough histories of arsenate and competing chloride, sulfate and bicarbonate anions in a fixed bed column exchanger using a polymeric ligand exchange resin (DOW 3N—Cu) loaded with cupric ions with the dashed line showing the calculated speciation curve of HAsO₄²⁻;

FIG. 5 is a graph illustrating arsenate uptake by a polymeric ligand exchange resin (DOW 3N—Cu) as a function of solution pH with the dashed line showing the calculated speciation curve of HAsO₄²⁻;

FIG. 6 is a graph illustrating the change in arsenate concentration in solution during the sorption of arsenate by a polymeric ligand exchange resin (DOW 3N—Cu) in a continuously stirred batch reactor;

FIG. 7 is a graph illustrating the arsenate elution profile and recovery during regeneration of an arsenate saturated polymeric ligand exchange resin (DOW 3N—Cu) using 4% (w/w) sodium chloride at pH 4.1, 7.0 and 9.1, respectively;

FIG. 8 is a bar graph illustrating arsenate uptake of a virgin polymeric ligand exchange resin (DOW 3N—Cu) as compared to the resin after each of eight consecutive operating and regeneration cycles;

FIG. 9 is a graph illustrating arsenate removal from spent regenerant brine using iron chloride (FeCl₃) as a function of the Fe:As molar ratio and at a fixed pH of 6.0, 7.0 and 9.0, respectively; and

FIG. 10 is a graph illustrating the regeneration of an arsenate-saturated polymeric ligand exchange resin (DOW 3N—Cu) using treated spent brine at pH 10.

### DETAILED DESCRIPTION OF THE INVENTION

The entire disclosure contained in U.S. Pat. No. 6,136,199 is specifically incorporated herein by reference.

Polymeric ligand exchangers (PLE) are well-known in the art, and are a class of promising sorbents that sorb chemicals based primarily on their ligand characteristics rather than ionic charges. Consequently, selective removal of trace contaminants or toxic compounds that are strong ligands can be achieved using a PLE. The present invention relates to the use of an innovative PLE for selective removal of trace contaminants and toxic compounds from water, especially drinking water, in the presence of various competing ions.

Preparation of PLEs may be conducted by loading various Lewis acid metals onto a chelating resin containing nitrogen electron donor atoms, such as DOW 3N and DOW 2N, both available from the Dow Chemical Company. These chelating resins serve as excellent metal hosting polymers and each has pyridine-nitrogen atoms in the polymer phase that binds with metal ions more effectively then amine-nitrogen atoms. The chelating resin of the PLE may be prepared by loading one or more transition metal ions such as a cupric ion (Cu²⁺), a cuprous ion (Cu¹⁺), a ferric ion (Fe³⁺), a ferrous ion (Fe²⁺), a nickel ion (Ni²⁺), a zinc ion (Zn²⁺), a zirconium ion (Zr⁴⁺), a cobalt ion (Co²⁺) and a chromium ion (Cr³⁺) onto one or more of the chelating resins. Loading of each metal may be carried out in separate, stirred batch reactors and by equilibrating virgin DOW 3N or virgin DOW 2N with one liter of each solution containing about 300-500 mg/L of the respective transition metal. The resin to solution ratio is preset to ensure that maximum uptake capacity for each metal is obtained. The pH of the solutions should range from about 4 to about 5 and thus no precipitation of any corresponding metal hydroxide should occur. Equilibration should take approximately one day for each metal loading. Upon saturation, all loaded sorbents should be separated from solution, rinsed using de-ionized water, and air dried for use. The resultant metal loaded DOW 3N resin may be designated as DOW 3N-Me, in general, and for example, DOW 3N—Cu, or DOW 3N—Ni, or DOW 3N—Fe, or DOW 3N—Zn, or DOW 3N—Co, or DOW 3N—Cr, or DOW 3N—Zr depending upon the metal ion loaded onto the PLE.

With regard to the sorbents, chelating resins containing nitrogen electron donor atoms serve as the metal hosting polymers, and as noted above, pyridine-nitrogen atoms in the polymer phase bind with the metal ions very effectively. The nitrogen donor atoms in the chelating polymers interact with various metal ions in accord with the Irving-Williams Series, with the highest affinity being observed for cupric ions (Cu²⁺). Preferred chelating resins are those referred to above as DOW 2N and DOW 3N, but another chelating resin, know as XUS 43578, also available from the Dow Chemical Company, may also be employed as the metal hosting polymeric resin. Table 2 provides important properties for these resins. DOW 2N, DOW 3N, and XUS 43578 may all be purchased from the Dow Chemical Company, Midland, Mich. or from Sigma-Aldrich, Bellefonte, Pa. The DOW 2N and DOW 3N resins are synthesized by attaching, respectively, N-(2-hydroxypropyl)picolylamine and bispicolylamine functional groups to a macroprous polystyrene divinylbenzene copolymer, and are manufactured in spherical form, preferably with uniform diameters. Since both of these resins contain pyridyl and tertiary-amine groups as functional groups, they are classified as weak base chelating resins.

For comparison purposes, two additional commercially available strong base anion (SBA) resins were also prepared. These two resins were IRA-958 and IRA-900 both available from Rohm & Haas of Philadelphia, Pa. Information on these two sorbents is also provided in Table 2, and it is noted that these metal hosting polymers contain amine-nitrogen atoms as opposed to the pyridine-nitrogen atoms in the DOW 2N, DOW 3N and XUS resins.

Once the PLE is prepared, the method involves contacting water containing a toxic compound or trace contaminant with the PLE to remove the toxic compound or trace contaminant from the water. Continuous or batch operation may be utilized as long as sufficient time is allowed for contacting the contaminated water with the PLE.

Important trace contaminants or toxic compounds that may be removed from water when contacted with a PLE prepared in accordance with present method, include arsenic, selenium, cyanide, perchloride, and mixtures thereof. The preferred contaminant or toxic compound to be removed is arsenic. As known by those skilled in the art, the toxic compound is removed as its salt i.e., arsenate, selenate, cyanate, and perchlorate.

Table 2 indicates that both DOW 2N and DOW 3N contain only free-base form (non-charged) nitrogen atoms as electron donors. DOW 2N contains two nitrogen donor atoms (1 pyridyl-N and one amine-N) per functional group, while DOW 3N carries three (2 pyridyl-N and one amine-N). It is to be noted that the weight fraction of total nitrogen in these two resins is quite comparable (7.3% by weight DOW 2N and 8.95% by weight DOW 3N). However, DOW 3N exhibits a much higher (almost double) capacity than DOW 2N for the uptake of copper. In other words, the uptake of each mole of cupric ion (Cu²⁺) consumes two functional groups for DOW 2N but only one functional group for DOW 3N. Given the otherwise similar properties for DOW 3N and DOW 2N, it is to be noted that DOW 3N is preferred over DOW 2N since (a) the pyridyl-N atoms are more efficient donors than amine-N atoms for metal binding; (b) for DOW 3N, each functional group can bind with one cupric ion (Cu²⁺); (c) for DOW 2N, at least two functional groups are necessary to bind one cupric ion (Cu²⁺).

The present invention is further described by the following illustrative examples.

### EXAMPLES

Materials and Methods

Materials

A total of three sorbents were tested in this study, including the copper-loaded PLE (DOW 3N—Cu), and two commercial SBA resins (IRA 900 and IRA 958). DOW 3N—Cu was prepared by loading Cu²⁺ ions onto a commercial chelating ion exchange resin (DOW 3N), purchased from Aldrich (Milwaukee, Wis., USA). The copper loading procedures used by Zhao and SenGupta (1998) were slightly modified. In brief, DOW 3N was first conditioned through cyclic acid and base washing using IN HCl and 1N NaOH, respectively. Upon rinsing using deionized (DI) water, the resin was equilibrated with 0.1% (w/w) copper solution at pH 3.5-4.0 for two weeks. Analytical grade CuCl₂.2H₂O (Aldrich, Milwaukee, Wis., USA) was used for preparing the copper solution. The resin-to-solution ratio was, approximately 1:200 (w/w). To enhance copper loading, the resin solution mixture was intermittently heated at 70° C. for about 4 hours every other day and then placed back at ambient temperature (about 21° C.). (Note: mild heating can cause resin swelling and enhance aging, thereby enhancing the copper loading kinetics and stability). To avoid oxidation of the resin matrix, nitrogen gas was blown in the solution during heating. Upon completion, the copper loaded resin was thoroughly rinsed using DI water and air dried for use.

For comparison, two commonly used conventional SBA resins, known as IRA 900 and IRA 958 were also tested in this study. Table 1 gives important properties of these sorbents. Before use, the resins were conditioned following the same acid base washing procedure as described above. All resins were prepared in the chloride form.

The following chemicals (all in analytical grades) were purchased from Fisher Scientific (Pittsburgh, Pa., USA): FeCl₃, NaOH, NaHCO₃, Na₂SO₄, and NaCl. Reagent grade of sodium hydrogen arsenate (Na₂HAsO₄.7H₂O) was purchased from (Aldrich, Milwaukee, Wis., USA).

Equilibrium Sorption Tests

Batch isotherm tests were carried out for all the three resins in 60 mL glass vials with Teflon-lined screw caps. The tests were initiated by adding known masses (0.004 g to 0.15 g) of a resin to 50 mL of a solution containing an initial concentration of 10 mg/L As and 100 mg/L sulfate. The mixture was then shaken on a rotating tumbler for 7 days, which were sufficient to reach equilibrium as confirmed through separate kinetic tests. The initial pH of the solution was about 7.5, and pH during equilibration was maintained in the range of 7.0-7.5 through intermittent adjusting using dilute NaOH or HCl until final equilibrium was reached. At equilibrium, water samples were taken from each vial and analyzed for As and sulfate remaining in water. Arsenic or sulfate uptake was then calculated based on the mass balance equation,

$${q}_{e} = \frac{V ( {C}_{0} - {C}_{e} )}{M}$$

where qₑ is the equilibrium mass uptake of As by a sorbent (mg/g), V is the solution volume (L), C₀ and Cₑ are the initial and final concentration of arsenic or sulfate in solution, respectively (mg/L), and M is the mass of a sorbent added (g). All tests were carried out at room temperature (about 21° C.).

Fixed-Bed Column Tests

The breakthrough behaviors of arsenate as well as various competing anions were tested for DOW 3N—Cu and IRA 900 in a fixed-bed configuration. The experimental set-up included a Plexiglass column (11 mm in diameter and 25 cm in length), an Accuflow Series II high-pressure liquid chromatography stainless steel pump, and an Eldex automatic fraction collector. Approximately 5 mL of a resin was used in each run. Simulated contaminated water was introduced in the resin bed in a down-flow mode. The major compositions in the influent water were as follows: for IRA 900, As=75 μg/L, SO₄²⁻=1.9 meq/L, Cl=2.4 meq/L, and pH=8.3; for DOW 3N—Cu: As=94 μg/L, SO₄²⁻ meq/L, HCO₃⁻=0.50 meg/L, Cl=1.3 meq/L, and pH=8.6. A constant flowrate of 1.2 mL/min was maintained, which translates to an empty bed contact time (EBCT) of 4.1 minutes, and a superficial liquid velocity (SLV) of 3.0 m/hr.

pH Effect

The pH effect on equilibrium uptake of arsenate was tested for DOW 3N—Cu in a similar fashion to that in the isotherm tests. However, the final solution pH was adjusted to span from 2.8 to 11 (each vial had a different pH). Each testing vial contained 50 ml solution with an initial As of 8.3 mg/L and SO₄²⁻ of 86 mg/L. The sorption was initiated upon the addition of about 0.020 g of air-dried DOW 3N—Cu to each vial.

Kinetic Tests

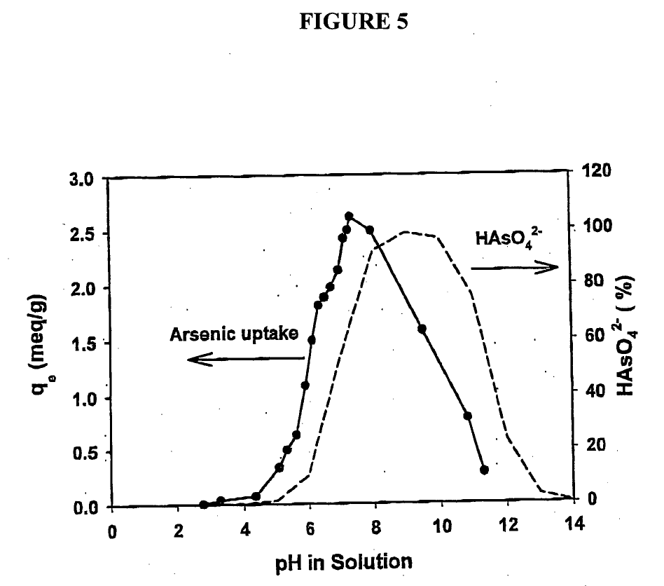

Batch kinetic test was conducted to test the arsenic sorption rate and determine the effective intraparticle diffusivity for DOW 3N—Cu. The experiment was initiated by adding 0.95 g of the sorbent into 2 L of a solution containing 5 mg/L As and 100 mg/L sulfate and at an initial pH of 8.0. The solution pH was adjusted intermittently by adding small amounts of dilute NaOH to keep the solution pH within 7.0-7.6, where pH effect on the PLE's uptake was minimal (FIG. 5). During the experiment, the resin-solution mixture was intensively agitated on a shaker to eliminate the possible film diffusion limitation on the mass transfer process. At predetermined time intervals, water samples (about 2 mL/each) were taken and analyzed for As. The As uptake at various times was then, determined through mass balance calculations.

Resin Regeneration, Reuse of Regenerated Resin, and Regenerant Treatment and Reuse

Regeneration of arsenic loaded DOW 3N—Cu was carried out in the same fixed-bed column configuration and in the down-flow mode. In search for an optimal regenerant recipe, a 4% (w/w) NaCl solution at pH 4.1, 7.0, and 9.1 was tested in separate column runs. The operating hydrodynamic conditions were maintained identical for all cases, including an empty bed contact time (EBCT) of 22 minutes and a superficial liquid velocity (SLV) of 14 m/hr.

Sorption capacity of DOW 3N—Cu that was subjected to up to 8 saturation-regeneration cycles was compared to that of the virgin DOW 3N—Cu. The best regenerant (i.e. 4% NaCl at pH=9.1) was employed to regenerate the resin repeatedly. Equilibrium sorption of As was in a similar manner as described in previously herein, with the following conditions: initial As=about 10 mg/L, initial SO₄²⁻=100 mg/L, resin weight=0.01 g, solution volume=50 mL, final pH=7.0-7.5.

To study the treatability of spent regenerant brine, about 2 L of a simulated spent brine solution was prepared based on the analysis of the spent brine collected from prior fixed-bed regeneration tests. The primary compositions of the spent brine were: As=300 mg/L, SO₄²⁻=600 mg/L, HCO₃⁻=305 mg/L, and NaCl=4% (w/w) (or 24 g/L as Cl). The solution was dispensed into a number of Nalgene HPDE sample bottles at 100 mL/bottle. Ferric chloride was then added to the bottles at Fe/As molar ratios of 5, 10, 15, 20, 25, 30, and 40, respectively. The mixture was then mixed on a gang mixer for about 2 hours, with pH being adjusted intermittently to a desired value, and then allowed the precipitates to settle for about 1 hr. When the ferric precipitates were fully settled, approximately 5 mL of supernatant was sampled from each bottle, centrifuged and analyzed for As remaining in water. To study the pH effect on As removal, the experiments were carried out in three separate sets with a final pH of 6.0, 7.0, and 9.0, respectively. The solution pH was maintained by adding known quantities of NaOH in the solution.

To test the reusability of the brine, the treated brine supernatant was separated from the precipitates, adjusted to pH −10, and then tested for regenerating an As-laden DOW 3N—Cu bed under the same conditions as in the above regeneration test using the fresh brine.

Chemical Analyses

Arsenic and copper were analyzed using a Perkin Elmer Atomic Adsorption Spectrophotometer, which has a detection limit of 3 μg/L As. Solution pH was measured using an Orion pH meter (model 520A). Sulfate and chloride ions were analyzed using a Dionex Ion Chromatograph (Model DX-120). Bicarbonate was analyzed with a UV-Persulfate TOC Analyzer (Phoenix 8000). Results and discussion

Equilibrium Isotherms and Nature of Arsenate Sorption

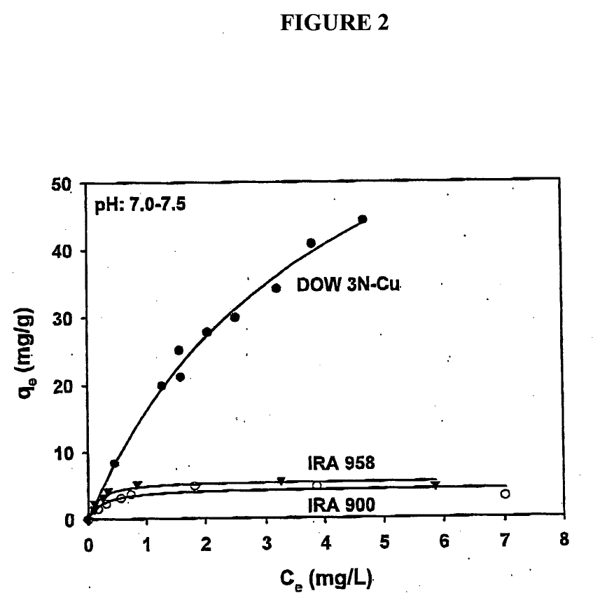

As mentioned before, one of the critical limitations for current SBA resins is its low selectivity and sorption capacity for arsenate especially in the presence of some omnipresent anions such as sulfate. To probe the PLE's sorption capacity, arsenate sorption isotherms were constructed for DOW 3N—Cu in the presence of 100 mg/L sulfate as competing anions. For comparison, arsenic isotherms were also measured for the two commercial SBA resins (IRA 900 and IRA 958) under otherwise identical conditions. The equilibrium pH was maintained at 7.0-7.5 in all cases to minimize the pH effect on the uptake (see FIG. 5). FIG. 2 shows the observed (symbols) and simulated (lines) isotherms for the three sorbents. The classical Langmuir model was employed for fitting the experimental data,

$${q}_{e} = \frac{{bQC}_{c}}{1 + {bC}_{c}}$$

where qₑ is the equilibrium As uptake (mg/g), C_{c} is the equilibrium concentration of As in water (mg/L), and b and Q are the Langmuir affinity and capacity coefficients, respectively. The non-linear fitting was performed using the SigmaPlot8.0. Table 2 lists the model-fitted b and Q values.

The binary separation factor has been commonly used to compare the relative affinity of a sorbent for various competing sorbates. In a binary system, the arsenic/sulfate separation factor (α_{As/S}) is defined as:

$${α}_{As / S} = \frac{{Q}_{As} {C}_{S}}{{C}_{As} {q}_{S}}$$

where q and C represent the concentration of As in the polymer phase and in the aqueous phase, respectively; As and S in the subscripts denote arsenic and sulfate, respectively. In general, a value of α_{As/S} of greater than unity indicates the resin's preference toward arsenic over sulfate, whereas the opposite is true if α_{As/S} is less than unity. The greater the α_{As/S} value, the more selective is the resin for arsenate. Based on the experimental equilibrium sorption data in FIG. 2, the average separation factor was calculated for the three resins and is given in Table 2. The α_{As/S} value of DOW 3N—Cu is about 12, which clearly indicates the resin's preference toward arsenate over sulfate. In contrast, the α_{As/S} value for the commercial resins was 0.1 for IRA 900, and 0.2′ for IRA 958, which is consistent with the literature that these resins are more favorable for sulfate.

The substantially improved As selectivity of DOW 3N—Cu is attributable to the concurrent Lewis acid-base interaction and electrostatic interactions between arsenate and the immobilized Cu²⁺ ions at the sorbent-sorbate interface. Under the experimental conditions, mono-hydrogen arsenate (HAsO₄²⁻) is considered the predominant arsenate species (see FIG. 5 for details). HAsO₄²⁻ is a divalently charged, bidentate ligand, and a strong Lewis base (donor of electron lone pairs). The competing sulfate is also a divalently charged ligand, but it is a much weaker Lewis base. Consequently, interactions between arsenate and the immobilized Cu²⁺ ions involve both Lewis acid-base interaction (or inner-sphere complexation) and ion pairing (or electrostatic interactions), while interactions between sulfate and the Cu²⁴ ions is predominantly ion paring. It is noteworthy that Lewis acid-base interaction also enhances the electrostatic interactions between arsenate and the loaded Cu²⁺ ions. This is because the inner-sphere complexation occurs over a much shorter distance than outer sphere complexation as is the case for sulfate, and the electrostatic interactions within the much shortened distance are much stronger in accord with the Coulomb's law. Consequently, DOW 3N—Cu offered much greater affinity for arsenate over sulfate. For the commercial SBA resins, the quaternary amine functionalities (RN⁺(CH₃)₃) take up anions predominately through electrostatic interactions, i.e., the ligand strength of an anion does not play a role in sorption affinity. Therefore, SBA resins are not selective for arsenate.

The underlying mechanism for the enhanced arsenate sorption by DOW 3N—Cu can also be revealed by inspecting the fundamental thermodynamic driving forces, i.e., the overall standard free energy change (ΔG⁰₀). For arsenate sorption by DOW 3N—Cu, ΔG⁰₀ is composed of two synergistic terms as shown in the following equation:
ΔG_{O}^{o}=ΔG_{EL}^{o}+ΔG_{LAB}^{o}
where ΔG⁰_{EL} is due to electrostatic interactions and ΔG⁰_{LAB} is to the Lewis acid-base interaction (i.e. metal-ligand complexation). Compared to arsenate, other anions such as sulfate, nitrate and chloride are much weaker ligands, namely, only ΔG⁰_{EL} in the above equation is operative, thus the resultant driving force (ΔG⁰₀) for these anions is much smaller than that for arsenate. Commercial SBA resins interact with anions through only electrostatic interactions (i.e., ΔG⁰_{LAB}≈0). Therefore, DOW 3N—Cu is able to take advantage of the strong ligand characteristics of arsenate over other competing anions and to achieve highly selective removal of arsenate.

Breakthrough Behaviors

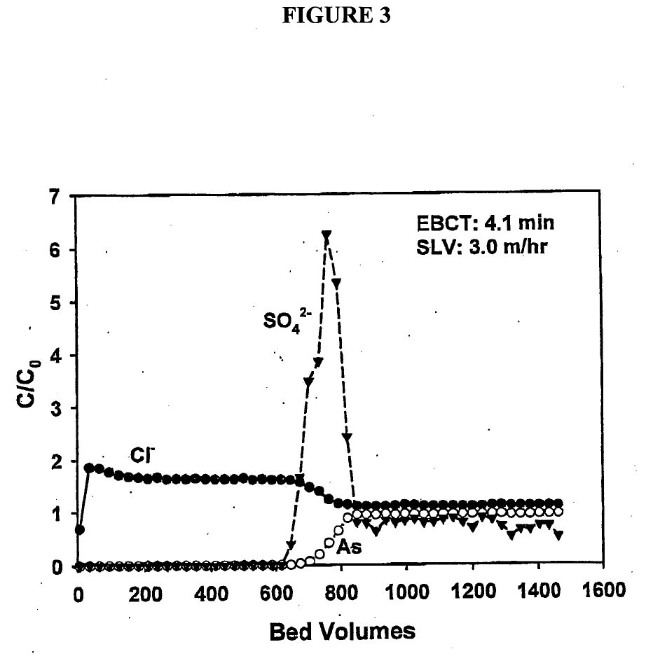

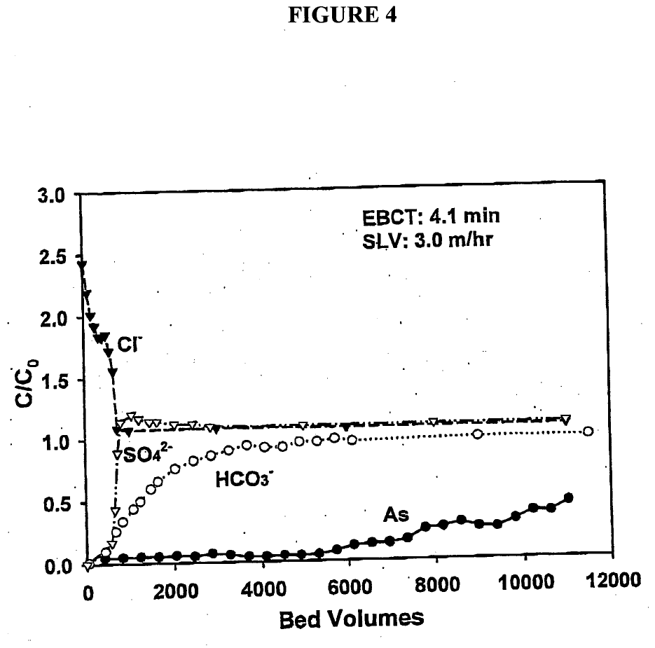

FIGS. 3 and 4 show the breakthrough histories of arsenate and other competing anions during the fixed-bed column experiments using IRA 900 and DOW 3N—Cu, respectively. FIG. 3 shows that for IRA 900, the sulfate breakthrough occurred about 100 bed volumes (BVs) later than the arsenate breakthrough, confirming the resin's greater affinity for sulfate over arsenate. FIG. 3 also reveals a sharp chromatographic peaking of the arsenate breakthrough curve, which again indicates that this commercial SBA resin favors sulfate much more than arsenate. Due to the strong competition from sulfate, IRA 900 can treat only about 600 BVs of contaminated water per operation cycle (a cycle=saturation run+regeneration run). The breakthrough sequence of the anions reveals the following selectivity order for IRA 900:
SO₄²⁻>HAsO₄²⁻>Cl
Field data from Albuquerque, N.Mex., USA, showed that As breakthrough took place typically within about 450 BVs, using SBA commercial resins.

In contrast, a completely different breakthrough behavior was observed when DOW 3N—Cu was used. FIG. 4 shows that all three competing anions broke through before 500 BVs. Based on the new MCL value of 10 μg/L for As, arsenate breakthrough did not occur until after 6,000 BVs, i.e. the PLE can treat over 10 times more water than IRA 900 in each run. A minor chromatographic peaking of sulfate was observed. The breakthrough sequence indicates the following selectivity sequence:
HAsO₄²⁻>>HCO₃⁻>SO₄²⁻>Cl
It is noteworthy that the monovalent bicarbonate displayed slightly greater affinity over the divalent sulfate, which is not surprising given that bicarbonate is a stronger ligand than sulfate.

Effect of pH

As in any ion exchange process, the PLE's selectivity for various competing ligands can be strongly impacted by solution pH. Solution pH can affect the PLE's arsenic uptake in two different aspects. First, solution pH governs the speciation of arsenate, resulting in arsenate species (H₃AsO₄, H₂AsO₄⁻, HAsO₄²⁻ and AsO₄³⁻) of different ionic charges and ligand strength. Second, the hydroxyl anions become aggressively formidable competitors for the ligand exchange sites as solution pH goes up.

FIG. 5 shows the observed arsenate uptake data as a function of the equilibrium solution pH. Note that sulfate at an initial concentration of 86 mg/L was present for all points tested. Also superimposed in FIG. 5 is the speciation curve of the HASO₄²⁻ species as a function of solution pH calculated based on the reported pKₐ values. FIG. 5 indicates that the optimal arsenate uptake occurs in the pH range of about 6.0 to about 8.0, with the peak uptake being at pH about 7.0. At pH<4.0 or pH>11, there was virtually no uptake of arsenate observed, It is also interesting that As uptake started increasing at pH about 4.0 almost in proportion to the increasing formation of the bidentate hydrogen arsenate species (HAsO₄²⁻). However, the As uptake drops sharply as pH exceeds about 8.0.

The acid dissociation constants (pKₐ) for arsenate are: pKₐ₁=2.2, pKₐ₂=6.9, and pKₐ₃=12. Based on both ligand strength and ionic charge, the absorbability of various arsenate species follows the sequence of H₃AsO₄<H₂AsO₄⁻<HAsO₄²⁻<AsO₄³⁻. At pH<4.0, the much less adsorbable H_{2AsO}₄⁻ or H₃AsO₄⁻ is the predominant arsenate species, which can not stand the competition of divalently charged sulfate anions. As a result, no As uptake is likely in the low pH range as observed in FIG. 5. The fact that the As uptake appears to be in proportion to the formation of HAsO₄²⁻ in the pH range of 4.0-7.0 agrees with the notion that to overcome the competition from sulfate, arsenate must be converted to the more adsorbable HAsO₄²⁻ species. However, comparing the As uptake and HAsO₄²⁻ speciation curves, it appears counter-intuitive in the sense that formation of HAsO₄²⁻ and its uptake did not really take place concomitantly, i.e. there appears to be a pH shift (about 1 pH unit) between the uptake curve and the HAsO₄²⁻ formation curve.

The observed pH shift reveals that the pH at the ligand exchange sites is actually higher than that in the bulk solution phase. This is in accord with the Donnan co-ion exclusion principle. The immobilized Cu²⁺ ions in DOW 3N—Cu tend to attract counter-ions including OH⁻ to the close vicinity of the resin surface, and simultaneously exclude co-ions including H⁺ away from the surface. As a result, an excess of OH⁻ at the resin-solution interface is built up, which promotes the conversion of the H₂AsO₄⁻ from the bulk solution to H₂AsO₄²⁻ at the resin surface. This interfacial pH shift was also observed by Zhao and SenGupta (2000) in their study on phosphate uptake by DOW 3N—Cu. At pH above 8.0, although the more adsorbable HASO₄²⁻ ions are the predominant species, the competition from OH⁻ ions becomes increasingly fierce, resulting in the increasing reduction in As uptake as pH goes up.

From a practical view point, the optimal pH range of 6.0-8.0 is quite novel. Since the pH value for most natural waters falls in this range, there is no need to adjust source water pH to achieve the PLE's maximal sorption capacity.

Kinetic Test

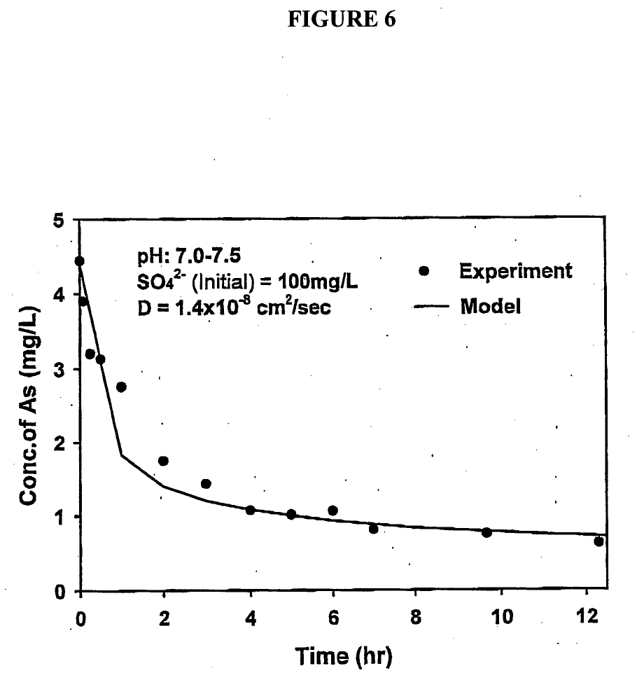

In a prior study on phosphate sorption, Zhao and SenGupta (2000) identified that intraparticle diffusion is the rate-limiting step during sorption of phosphate to DOW 3N—Cu. They also determined the effective intraparticle diffusivity for phosphate to be 1.0×10⁻⁸ cm²/s. Given the molecular analog between phosphate and arsenate, the intraparticle diffusivity is determined in a similar manner. FIG. 6 presents the change in As concentration in solution during the transient sorption of As by DOW 3N—Cu in a continuously stirred batch reactor.

For intraparticle-diffusion-controlled process, sorption rates are often modeled based on the Fick's second law. For spherical sorbents, the governing equation is (Crank, 1975)

$$\frac{\partial q}{\partial t} = D ( \frac{{\partial }^{2} q}{\partial {r}^{2}} + \frac{2 \partial q}{r \partial r} )$$

where r is the radial coordinate and q(t, r) is the solid-phase arsenic concentration at time t. Under the experimental conditions, the following initial and boundary conditions apply:
q(0) at 0≦r≦α
∂q/∂r=0 at r=0
(∂q/∂r)(3D M/a)=−V(∂C/∂) at r=a
where a is the mean radius of the resin beads, which was determined to be about 0.22 mm, M is the mass of the resin added, and V is the solution volume, which is considered constant during the course of the experiment.

The above system conforms to the scenario where diffusion takes place in a well-stirred solution of limited volume (Crank, 1975). The solution given by Crank (1975) as the fractional attainment of equilibrium (F),

$$F = \frac{q ( t )}{{q}_{∞}} = 1 - {\sum }_{n = 1}^{∞} \frac{6 α ( α + 1 ) exp ( - {Dq}_{n}^{2} t / {a}^{2 )}}{9 + 9 α + {q}_{n}^{2} {α}^{2}}$$

where q_{∞} is the arsenate uptake by DOW 3N—Cu at infinite time (i.e. at equilibrium), the parameter α is expressed in terms of the final fractional uptake of arsenate as

$$\frac{{Mq}_{∞}}{{V}_{o} {C}_{o}} = \frac{1}{1 + a}$$

where Vₒ, and Cₒ are initial solution volume and initial arsenate concentration in solution, respectively. The qₙ's are the non zero roots of

$$tan {q}_{n} = \frac{3 {q}_{n}}{3 + α {q}_{n}^{2}}$$

The form of this equation is convenient in bracketing the roots in well-defined intervals as determined by the tan function, which allows for simple root finding using the method of bisection.

The aqueous phase concentration at time t, C(t), was determined using the following mass-balance equation:
Mq(t)=V[Cₒ−C(t)]
The best fit of the model to the experimental kinetic data in FIG. 6 was achieved by adjusting the diffusivity value (D) until the sum of the squared error is minimized, which yields a diffusivity value of 1.4×10⁻⁸ cm²/s. This value is comparable in the order of magnitude to that for commonly used standard macroporous SBA resins.

Resin Regeneration, Reuse of Regenerated PLE, and Reuse of Treated Spent Regenerant

From the standpoints of both cost-effectiveness and environmental friendliness, it is highly desirable that an ion exchange resin be amenable to efficient regeneration using cheapest possible regenerant. Furthermore, it is even more beneficial if the spent regenerant can be recycled and reused. Multiple reuses of regenerant brine can further reduce the brine needs and cut down the volume of process waste residuals. Minimizing process waste residuals is currently gaining increasing attention in the U.S. due to the much tightened regulations on the waste discharge.

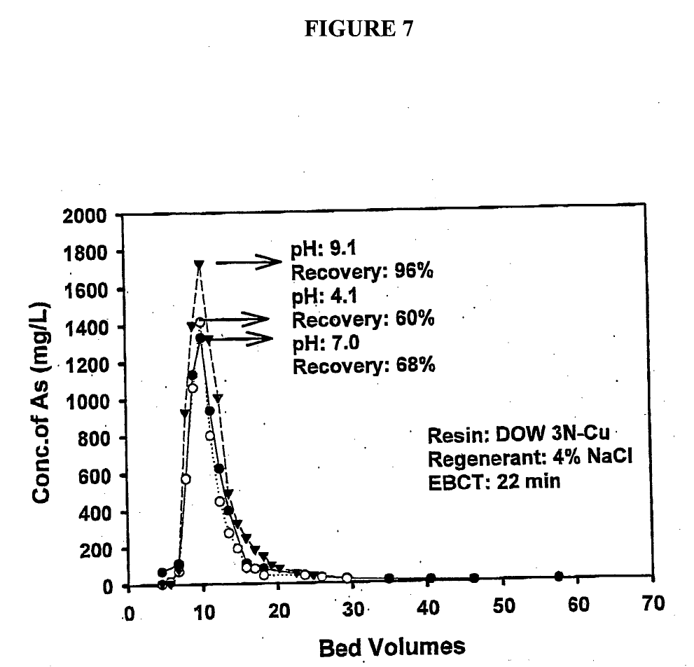

Regeneration of arsenate-saturated DOW 3N—Cu was tested in the same fixed-bed configuration. FIG. 7 compares arsenate elution profile and recovery during regeneration using 4% (w/w) NaCl at pH 4.1, 7.0, and 9.1, respectively. As expected from the results in FIG. 4, greater regeneration efficiency was observed at acidic or alkaline pH than at neutral pH. At pH 9.1, more than 96% of sorbed arsenate was recovered within 30 BVs of the regenerant. The following equations illustrate the regeneration reaction stoichiometry at the, specified pH:

At pH 4.1
R—Cu²⁺HAsO₄²⁻+2Cl⁻+H⁺→R—Cu²⁺Cl₂⁻+H₂AsO₄⁻
At pH 7.0
R—Cu²⁺HAsO₄²⁻+2Cl⁻+x H⁺→R—Cu²⁺Cl₂⁻+(1−x)HAsO₄²⁻+x H₂AsO₄⁻
At pH 9.1
R—Cu²⁺HAsO₄²⁻+Cl⁻+OH⁻→R—Cu²⁺(Cl⁻)(OH⁻)+HAsO₄²⁻
Evidently, the participation of OH⁻in the ligand exchange reaction at alkaline pH greatly enhanced the regeneration efficiency.

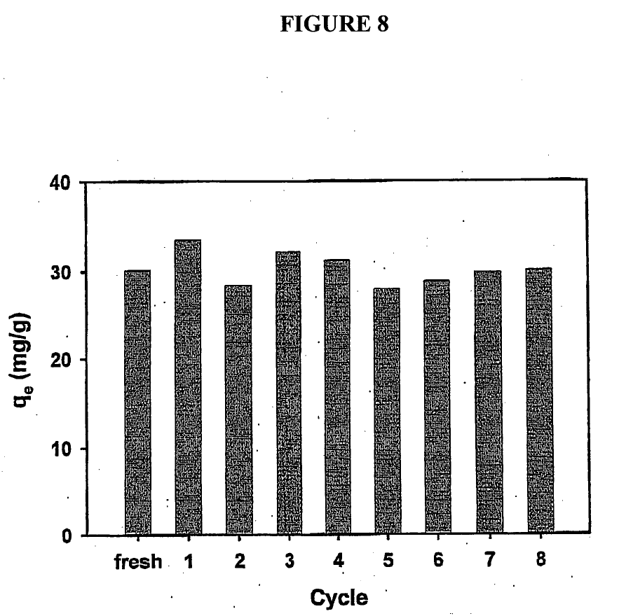

For practical viability, the PLE should be amenable to multiple cycles of operation without significant capacity drop. FIG. 8 compares the equilibrium uptake of As of virgin DOW 3N—Cu and when it was subjected to up to 9 consecutive operating cycles. Evidently, the regenerated DOW 3N—Cu did not show any significant capacity drop compared to its fresh form.

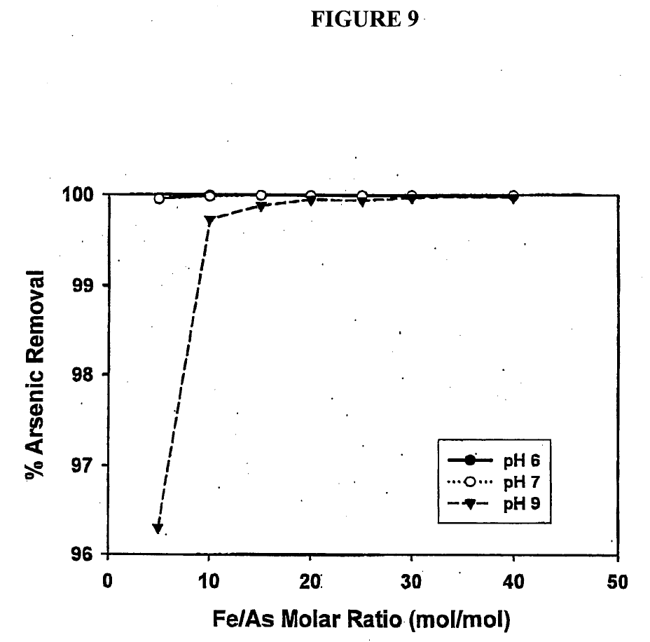

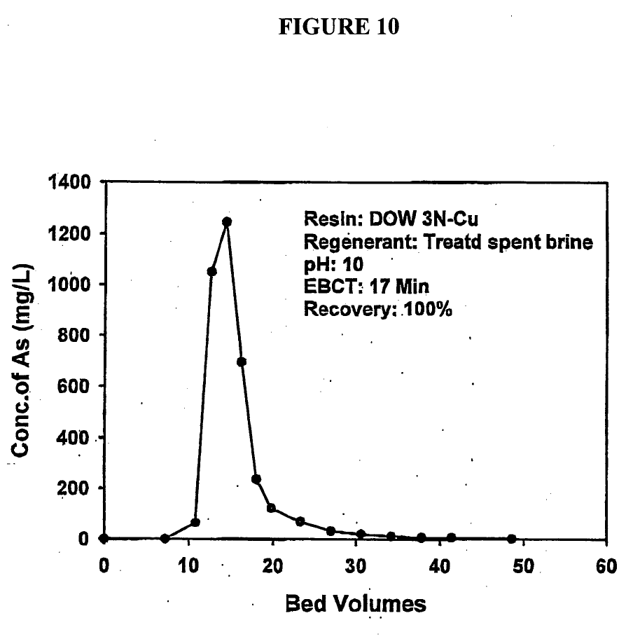

The high regeneration efficiency enables arsenate to be concentrated in a small volume (<1% of water treated) of spent regenerant. This affords the spent regenerant to be further treated using simple physical-chemical methods. It is highly desired to form a stable solid waste and to reuse the spent regenerant brine. To test the concept, ferric chloride was added to a batch of spent regenerant brine at various Fe:As molar ratios and at a fixed equilibrium pH of 6.0, 7.0, and 9.0, respectively. The primary compositions of the untreated spent brine were: As=300 mg/L as As, SO₄²⁻=600 mg/L, HCO₃⁻=305 mg/L, and NaCl=4% w/w (or Cl=24 g/L). FIG. 9 shows the removal of the concentrated As from the spent regenerant as a function of Fe:As ratio and the final pH. It is evident that more than 99.7% of As in the spent brine was removed at a Fe:As molar ratio of ≧10 and at pH 9.0. When pH was lowered to 6.0 or 7.0, over 99.9% As was removed at a Fe:As molar ratio of 5 or greater. Upon removal of the As-laden precipitates, pH of the supernatant was adjusted to 10 and then reused for another regeneration run. FIG. 10 shows nearly all arsenic capacity was recovered using about 30 BVs of the treated spent brine. The compositions of the treated brine were: As=about 50 μg/L, and Cl=30 g/L, with sulfate and bicarbonate being about the same before and after the treatment. Note that due to addition of FeCl₃, chloride was increased by about 25%, which favors the subsequent regeneration efficiency.

Conclusions

Metal-loaded resins hold the most promise for selective removal of arsenate. This study reveals that polymeric ligand exchangers may serve as a class of novel ion exchange resins for highly selective removal of arsenate from drinking water. Major findings of this study are summarized as follows:
The copper-loaded PLE, DOW 3N—Cu, showed unusually high selectivity for arsenate even in the presence of high concentrations of sulfate. Compared to conventional SBA resins, the arsenic selectivity of DOW 3N—Cu is 60-120 times greater based on the binary arsenate/sulfate separation factor.
Fixed-bed column tests indicate that DOW 3N—Cu can treat 10 times more water per operation cycle than the conventional SBA resins, which can potentially cut down the regenerant needs and the amount of process waste residuals by 90%.
DOW 3N—Cu can perform optimally in the pH range 6.0-8.0. Namely, there is no need to adjust pH to achieve the optimal arsenic capacity of the resin. The experimental’ results indicated a pH shift between the sorption sites and the bulk solution, i.e. pH at the ligand exchange sites was about 1 pH unit higher than pH in the bulk water. This pH difference promotes conversion of the less adsorbable H₂AsO₄⁻ to the more adsorbable HAsO₄²⁻ species even at a pH below the pKa2 value of arsenate (6.9).
The diffusivity of arsenate in DOW 3N—Cu is comparable to that for typical conventional macroporous sorbents.
DOW 3N—Cu can be highly efficiently regenerated using 4% NaCl at pH about 9.1, and can be used in multiple cycles of operation without loss in capacity.
Arsenic in the spent regenerant can be effectively removed using FeCl₃ at a Fe:As ratio of 5 to about 10 and a pH range of 6.0 to 9.0. The treated brine showed equally high regeneration efficiency, which further cuts down the regenerant needs.

Lastly, although no detailed cost estimation was attempted in this study, the potential cost effectiveness can be easily revealed. For instance, compared to conventional SBA resins, DOW 3N—Cu can treat ten times more water per cycle, which translates to a 90% cut in regenerant needs and 90% reduction in the treatment and disposal of the process waste residuals.

TABLE 1
Important properties of the ion exchange resins used in this study.

| | | | | |
|---|---|---|---|---|
| Sorbent | DOW 3N | DOW 2N | IRA 900 | IRA 958 |

| | | | | |
|---|---|---|---|---|
| Manufacturer | DOW Chemical | DOW Chemical | Rohm and Haas | Rohm and Haas |
| | Midland, MI, USA | Midland, MI, USA | Philadelphia, PA, | Philadelphia, PA, |
| | | | USA | USA |
| Functional Group | 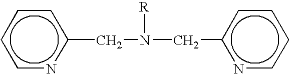 | 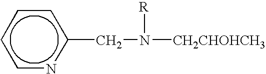 | 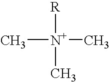 | 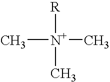 |
| Matrix | Polystyrene, Macro- | Polystyrene, Macroporous | Polystyrene, | Polystyrene, |
| | porous | | Macroporous | Macroporous |
| Capacity | 2.98^{a)} | 1.55^{a)} | 3.6^{a)} | 3.4^{a)} |
| (meq/g) | | | | |
| BET Surface | 139^{a)} | N/A | N/A | N/A |
| Area (m²/g) | | | | |

^{a)}From Henry et al., 2004

TABLE 2
The values of Q, b and α

| Resin | Q (Standard Error) | B (Standard Error) | α_{As/S} |
|---|---|---|---|
| DOW 3N—Cu | 83(7.9) | 0.24(0.038) | 12 |
| IRA 958 | 5.5(0.36) | 6.1(1.5) | 0.10 |
| IRA 900 | 4.5(0.51) | 4.1(2.1) | 0.20 |

I claim:

1. A method of removing toxic compounds from water, comprising the steps of:
providing a polymetric ligand exchanger having a chelating resin containing nitrogen electron donor atoms and a transition metal ion bonded with the nitrogen donor atoms on the surface of the chelating resin; and
contacting water containing a toxic compound with said polymeric ligand exchanger to remove the toxic compound from said water.

2. The method of claim 1 wherein said metal ion is selected from the group consisting of a cupric ion, a cuprous ion, a ferric ion, a ferrous ion, a nickel ion, a zinc ion, a zironconium ion, a cobalt ion, a chromium ion, and mixtures thereof.

3. The method of claim 1 wherein said metal ion is a cupric ion.

4. The method of claim 1 wherein said toxic compound is selected from the group consisting of arsenic, selenium, cyanide, perchloride, and mixtures thereof.

5. The method of claim 1 wherein said toxic compound is arsenic.

6. The method of claim 1 further including the step of regenerating the polymeric ligand exchanger with brine.

7. The method of claim 6 further including the step of treating the brine used to regenerate the polymeric ligand exchanger with an iron chloride to remove the toxic compound therefrom.

8. The method of claim 1 wherein the chelating resin contains a functional group having the formula: 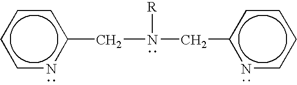
when R is a repeating monomer.

9. The method of claim 1 wherein the chelating resin contains a functional group having the formula: 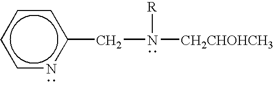
where R is a repeating monomer.
